(19) United States
(12) Patent Application Publication
(10) Pub. No.: US 2009/0274049 A1
(43) Pub. Date: Nov. 5, 2009

(54) NON-BLOCKED NETWORK SYSTEM AND PACKET ARBITRATION METHOD THEREOF

(75) Inventor: Chi Shao LAI, Hsinchu City (TW)

Correspondence Address: IPR WORKS, LLC, P.O. BOX 303, ATLANTIC HIGHLANDS, NJ, 07716, US

(73) Assignee: REALTEK SEMICONDUCTOR CORP., Hsinchu (TW)

(21) Appl. No.: 12/431,758

(22) Filed: Apr. 29, 2009

(30) Foreign Application Priority Data
May 2, 2008 (TW) 097116160

(51) Int. Cl. H04L 12/56

(52) U.S. Cl. 370/236

(57) ABSTRACT

A non-blocked network system and a packet arbitration method thereof are provided to dynamically adjust packet arbitration policy, thereby avoiding the congestion of packet traffic. The non-blocked network system includes a switch network, a source device and a target device. The switch network includes at least a first switch unit and a second switch unit. A first path and a second path connect between the first and second switch units. The target device is coupled to the second switch unit, and the source device is coupled to the first switch unit. Before issuing a first packet to the target device via the first path, the source device issues a corresponding token of the first packet to the second switch unit via the second path, so as to inform the second switch unit that the first packet will pass the first path soon. The second switch unit dynamically adjusts its packet arbitration policy according to the token, so as to determine the forwarding sequence of a second packet to be forwarded on the first path.

### BACKGROUND OF THE INVENTION

(a). Field of the Invention

The invention relates to communication networks, and more particularly to a non-blocked network system and a packet arbitration method thereof.

(b). Description of the Prior Arts

In recent years, the integrated circuit (IC) technology develops rapidly so that the System-on-Chip (SoC) approach is increasingly applied. The Network-on-Chip (NoC) architecture has also been developed to serve as the communication basis between system components. Since both the number of components and the need for bandwidth within a chip increase rapidly, the point-to-point standard protocol such as Open Core Protocol (OCP) or Advanced eXtensible Interface (AXI) is applied to the interface between the components so as to upgrade the working frequency and throughput of a NoC system. The physical layer of the NoC system utilizes point-to-point handshaking to control data flow and perform one-way phased transmission. The packet information provided by the standard protocol is used to facilitate data transmission and further provide the Quality of Service (QoS) function for data exchange. Packets, used for data exchange between the system components, may have different communication requirements depending on the involved components or tasks. For example, some of the packets need to be transmitted to their destination without too much delay so as to achieve a high data rate; the other packets may allow more delay in the transmission process.

FIG. 1 is an architecture diagram of a conventional NoC system 10, which includes switch units 11, 12 and 13, master devices 14, 15 and 16 and a slave device 17. The NoC system 10 adopts a multi-level, switch-to-switch structure wherein each switch unit forms a center of a cluster or communication sub-system, and one-way point-to-point shared signal paths 101, 102 and 103 respectively connect between the switch units 11 and 12, the switch units 12 and 13, and the switch unit 13 and the slave device 17, thereby transmitting packets across different levels. Since each switch unit may receive packets from multiple sources (including the master device and the switch unit at the previous level) at the same time and also the signal paths 101, 102 and 103 are shared, the switch unit should consider various communication requirements of the received packets so as to establish its packet arbitration policy for determining the forwarding sequence of the received packets. However, in the architecture of FIG. 1, there is only one single shared signal path between the switch units for forwarding packets, and no message channel between the switch units exists for exchanging information about communication quality. Thus, in the viewpoint of a specific switch unit, if another switch unit at the previous level is going to forward a packet which does not allow too much delay, or if a communication congestion is going to happen in the signal path of the previous level, the specific switch unit can not adjust its packet arbitration policy in time to deal with these situations.

On the other hand, if multiple signal paths are created to avoid the congestion problem resulted from the single signal path, then both the cost and layout complexity of the NoC system will unfavorably increase.

### SUMMARY OF THE INVENTION

It is therefore one objective of the present invention to provide a non-blocked network system and a packet arbitration method thereof that can dynamically adjust the packet arbitration policy so as to avoid the congestion of packet traffic.

In one embodiment of the present invention, a network system is provided. The network system comprises: a switch network comprising at least a first switch unit and a second switch unit, wherein a first path and a second path connect between the first and second switch units; a target device coupled to the second switch unit; and a source device, coupled to the first switch unit, for issuing a corresponding token of a first packet to the second switch unit via the second path before issuing the first packet to the target device via the first path, so as to inform the second switch unit that the first packet will pass the first path soon. The second switch unit dynamically adjusts a packet arbitration policy according to the token, so as to determine a forwarding sequence of a second packet to be forwarded on the first path.

In another embodiment of the invention, a network system is provided. The network system comprises: a switch network comprising at least a switch unit and a buffer, wherein the buffer generates a status signal to the switch unit, and the status signal is a near-full signal or a warning signal; and a target device coupled to the buffer and the switch unit. When a to-be-forwarded packet of the switch unit is a high priority packet, the switch unit forwards the high priority packet to the target device directly; when the to-be-forwarded packet is a low priority packet, the switch unit forwards the low priority packet to the buffer. The switch unit adjusts a packet arbitration policy according to whether receiving the status signal, so as to determine a forwarding sequence of the to-be-forwarded packet of the switch unit.

In another embodiment of the invention, a packet arbitration method used in a network system is provided. The network system comprises at least a first switch unit and a second switch unit, a source device coupled to the first switch unit, and a target device coupled to the second switch unit, wherein a first path and a second path connect between the first and second switch units. The packet arbitration method comprising steps of: the source device issuing a corresponding token of a first packet to the second switch unit via the second path before issuing the first packet, so as to inform the second switch unit that the first packet will pass the first path soon; and the second switch unit dynamically adjusting a packet arbitration policy according to the token, so as to determine a forwarding sequence of a second packet to be forwarded on the first path.

### BRIEF DESCRIPTION OF THE DRAWINGS

FIG. 1 is an architecture diagram of a conventional NoC system.

FIG. 2 is a diagram showing the architecture of another embodiment of the non-blocked network system according to the present invention.

FIG. 3 shows the format of packet header used in the embodiment of the present invention.

FIG. 4 shows the format of token used in the embodiment of the present invention.

FIG. 5 is a block diagram showing the buffering mechanism and the direct path added between the switch unit and the target device of FIG. 2.

FIG. 6 is a flow chart of a packet arbitration method according to a preferred embodiment of the present invention.

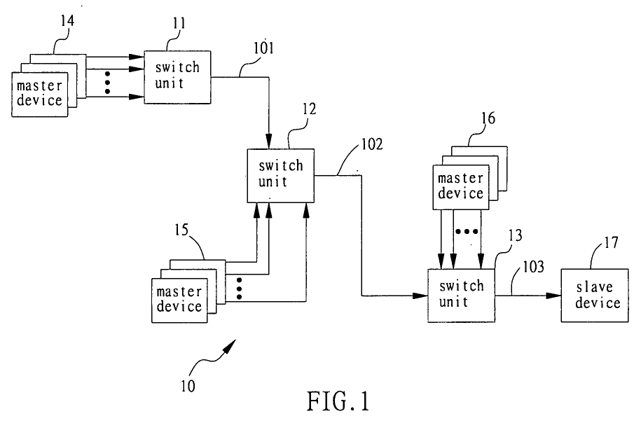

### DETAILED DESCRIPTION OF THE INVENTION

In an embodiment of the non-blocked network system of the present invention, the network system comprises a plurality of switch units for performing data exchange and transmission. There are two signal paths between any two connected switch units, where one of the two signal paths is used for forwarding packets (denoted as packet-forwarding path below), and the other is used for forwarding tokens (denoted as token-forwarding path; the meaning of token is described later). Each switch unit can be connected to one or more source devices or target devices. The source device is a master device, while the target device is a slave device. The source device can issue packets to a specific target device via one or more switch units (these packets are forwarded from one switch unit to another via the packet-forwarding path), so as to communicate with the specific target device. Each switch unit includes at least one routing unit and one arbitration unit. Each routing unit performs the routing function to determine which switch unit or target device to forward a packet or token received from some source device or another switch unit; each arbitration unit performs the arbitration function to determine the forwarding sequence of to-be-forwarded packets (or tokens) of one or more routing units.

If plural packets are to pass the packet-forwarding path between two connected switch units at the same time, congestion may occur on the packet-forwarding path. In particular, some packets with high priority need to reach the destination rapidly, and thus the switch unit must forward them as soon as possible. If these high priority packets cannot pass the packet-forwarding path rapidly due to congestion, the quality of network service will be lowered and even the network cannot work. Thus, in this embodiment, in order to prevent from congestion, before a source device issues a packet to a target device via a specific signal path (which is formed by combining one or more packet-forwarding paths), the source device will issue a corresponding token of the packet in advance to each switch unit on the whole specific path via independent token-forwarding paths, so as to inform the switch unit that one or more packets having a specific attribute (e.g. high priority or low priority) will soon pass a specific source packet-forwarding path of the switch unit to reach the switch unit. Here the source packet-forwarding path of a specific switch unit means the packet-forwarding path from which the specific switch unit receives packets. Thus, the informed switch unit can adjust its packet arbitration policy in time to deal with the coming packets, so as to prevent from congestion. For example, if the coming packet is a high priority packet, then the informed switch unit will make packet arbitration to forward one or more current to-be-forwarded low priority packets on its source packet-forwarding path in advance (otherwise the current to-be-forwarded low priority packet may be forwarded after too much waiting time due to low priority), so as to prevent the coming high priority packet from being blocked by the current to-be-forwarded low priority packet and let the coming high priority packet pass the source packet-forwarding path as soon as possible. It is notable that since the token is forwarded via independent signal paths and the size of the token is relatively small compared to that of the packet, the token can be transmitted very quickly and no congestion will occur, so as to reliably achieve the effect of informing the switch unit in advance. Furthermore, if the switch unit knows that a lot of packets will pass one of its source packet-forwarding paths soon according to the received token, then the switch unit will arbitrate to upgrade the transmission weight of this source packet-forwarding path (i.e. allocate more bandwidth to this path) so as to keep it uncongested.

The present invention can be applied to a NoC system, so as to prevent the NoC system from communication congestion. For example, in the above embodiment, the network system can be the NoC system which comprises plural source devices and target devices respectively coupled to some switch unit; the source device can be a direct memory access (DMA) controller, a digital signal processor (DSP), a CPU, a peripheral DMA, a LCD controller or an other IP component; the target device can be a DRAM controller, an internal memory controller, etc.

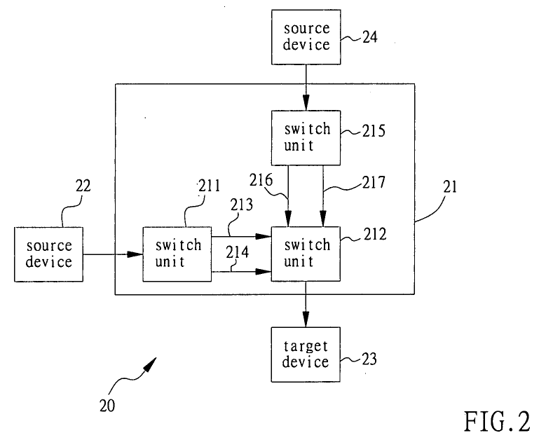

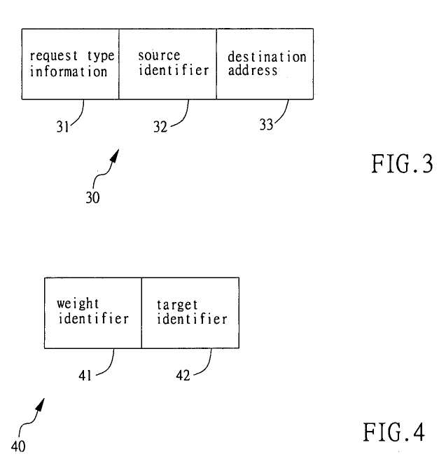

FIG. 2 is a diagram showing the architecture of another embodiment of the non-blocked network system according to the present invention, wherein the non-blocked network system 20 comprises a switch network 21, source devices 22 and 24, and a target device 23. The switch network 21 comprises switch units 211, 212 and 215, wherein a packet-forwarding path 213 and a token-forwarding path 214 connect between the switch units 211 and 212, and a packet-forwarding path 216 and a token-forwarding path 217 connect between the switch units 215 and 212. The source devices 22 and 24 are respectively coupled to the switch units 211 and 215, while the target device 23 is coupled to the switch unit 212. The source device 22 can issue packets to the target device 23 via the switch unit 211, the packet-forwarding path 213 and the switch unit 212, while the source device 24 can issue packets to the target device 23 via the switch unit 215, the packet-forwarding path 216 and the switch unit 212. When there are packets to be forwarded on the packet-forwarding paths 213 and 216 at the same time, the switch unit 212 performs packet arbitration to determine the forwarding sequence of these packets. For example, if the current to-be-forwarded packet on the packet-forwarding path 213 is a high priority packet and the current to-be-forwarded packet on the packet-forwarding path 216 is a low priority packet, then the switch unit 212 forwards the current to-be-forwarded packet on the packet-forwarding path 213 first. The packets are forwarded according to the point-to-point communication protocol, such as the OCP protocol and the AXI protocol. Each packet includes a header as shown in FIG. 3, wherein the header 30 comprises a request type information 31, a source identifier 32 and a destination address 33. The request type information 31 indicates the communication request of the packet; the source identifier 32 records the source device which issues the packet; the destination address 33 records the destination of the packet and is used by the switch units 211, 212 and 215 to perform the routing for the packet.

Before issuing a packet (denoted as the first packet below) to the target device 23, the source device 22 issues a corresponding token of the first packet in advance to the switch unit 212 via the token-forwarding path 214, so as to inform the switch unit 212 that the first packet will pass the packet-forwarding path 213 soon. The token, as shown in FIG. 4, is generated according to the header 30 of the first packet, and comprises a weight identifier 41 and a target identifier 42. The weight identifier 41 is formed by combining a subset of the request type information 31 and a subset of the source identifier 32. The subset of the request type information 31 can indicate the communication request type of the first packet (e.g. high priority or low priority), while the subset of the source identifier 32 can indicate the group of source devices (e.g. the group with high bandwidth request) which issues the first packet. The target identifier 42, decoded from the destination address 33, can indicate the target device which the first packet is destined to.

After receiving the token 40, the switch unit 212 updates a corresponding path weight of the packet-forwarding path 213 according to the token 40. The path weight is used to indicate a respective amount of to-be-forwarded packets corresponding to each different weight identifier on the packet-forwarding path 213. Thus, the path weight can show how much packets with different attributes on the packet-forwarding path 213 wait for forwarding by the switch unit 212. According to the weight identifier 41 in the received token 40, the switch unit 212 increases the amount of to-be-forwarded packets corresponding to the weight identifier 41 by one. On the other hand, since the first packet also contains the same weight identifier as the token 40, the switch unit 212 can decrease the amount of to-be-forwarded packets corresponding to the weight identifier 41 by one when forwarding the first packet subsequently, so as to maintain the correctness of the path weight.

In a first preferred embodiment, in the token, the subset of the request type information 31 included in the weight identifier 41 comprises a priority level information for indicating a priority level of the first packet. The priority level can be a high priority level or a low priority level. Correspondingly, the path weight of the packet-forwarding path 213 comprises a high priority weight and a low priority weight for respectively indicating an amount of high priority packets and an amount of low priority packets to be forwarded on the packet-forwarding path 213. When the switch unit 212 receives the token 40 issued before the first packet by the source device 22, the switch unit 212 can increase by one the high priority weight or the low priority weight of the path weight of the packet-forwarding path 213 according to that the first packet is a high priority packet or a low priority packet.

Similarly, before the source device 24 issues a packet to the target device 23, the source device 24 also issues a corresponding token of the packet in advance to the switch unit 212 via the token-forwarding path 217, so as to inform the switch unit 212 that the packet will pass the packet-forwarding path 216 soon. After receiving the token, the switch unit 212 updates a corresponding path weight of the packet-forwarding path 216 according to the token. The switch unit 212 also updates the path weight of the packet-forwarding path 216 when forwarding the packet subsequently.

By referring to the path weights of the packet-forwarding paths 213 and 216, the switch unit 212 knows the respective amount of to-be-forwarded packets with each kind of attribute, so as to adjust its packet arbitration policy. Then, the switch unit 212 arbitrates a packet forwarding sequence for forwarding the to-be-forwarded packets according to the adjusted packet arbitration policy. For example, in the first preferred embodiment described above, it is assumed that in the current path weight of the packet-forwarding path 213, the high priority weight is zero and the low priority weight is not zero, which means there is at least one to-be-forwarded low priority packet on the packet-forwarding path 213. If the first packet to be issued by the source device 22 is a high priority packet, then the corresponding token of the first packet will make the high priority weight be increased to one, which means a high priority packet will pass the packet-forwarding path 213 soon. Thus, the switch unit 212 adjusts its packet arbitration policy to forward the current to-be-forwarded low priority packet on the packet-forwarding path 213 earlier by regarding the current to-be-forwarded low priority packet as a high priority packet. In this manner, when the first packet with high priority passes the packet-forwarding path 213, the first packet is not blocked by the previous to-be-forwarded low priority packet.

In one embodiment, the switch unit 211 comprises a first sub switch unit, the switch unit 212 comprises a second sub switch unit, and the switch unit 215 comprises a third sub switch unit (not shown). The token-forwarding path 214 is coupled between the first sub switch unit and the second sub switch unit, while the token-forwarding path 217 is coupled between the second sub switch unit and the third sub switch unit. The first, second and third sub switch units are used to handle tokens only. Thus, in the switch network 21, the first, second and third sub switch units and the token-forwarding paths 214 and 217 form an independent sub switch network for handle and forward the token 40, thereby upgrading the transmission efficiency of the token 40 to prevent from congestion. The first, second and third sub switch units can perform routing function according to the target identifier 42 in the token 40 so as to forward the token 40. Also, the second sub switch unit can update the corresponding path weights of the packet-forwarding paths 213 and 216 according to the token 40.

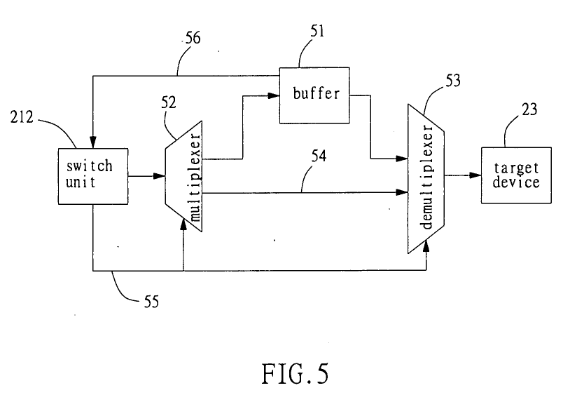

In a second preferred embodiment, in order to prevent the path from the switch unit 212 to the target device 23 from being blocked such that a subsequent high priority packet cannot pass as soon as possible, a buffering mechanism for temporally storing low priority packets is added between the switch unit 212 and the target device 23, and the status of the buffering mechanism is replied to the switch unit 212. Also, a direct path between the switch unit 212 and the target device 23 is established for forwarding high priority packets. The buffering mechanism and the direct path are shown in FIG. 5. When the switch unit 212 is going to forward a high priority packet, the switch unit 212 issues a control signal 55 to a multiplexer 52 and a demultiplexer 53 such that the high priority packet can be directly forwarded to the target device 23 via a direct path 54; when the switch unit 212 is going to forward a low priority packet, the switch unit 212 issues the control signal 55 to make the multiplexer 52 store the low priority packet into a buffer 51. The buffer 51 can provide a status signal 56 to the switch unit 212 so as to inform the current status of the buffer 51. In one embodiment, the status signal is a near-full signal or a warning signal. The near-full signal is used to indicate that the buffer 51 is near full (e.g. the current data amount or packet amount of the buffer 51 is higher than a first threshold) and cannot store any other packet; the warning signal is used to indicate that the empty space of the buffer 51 is limited (e.g. the current data amount or packet amount of the buffer 51 is higher than a second threshold while not higher than the first threshold) and can only store a few more packets.

The switch unit 212 can adjust its packet arbitration policy according to the near-full signal and the warning signal provided by the buffer 51, thereby preventing the direct path 54 between the switch unit 212 and the target device 23 from congestion. The adjustment can be performed as follows:

(1) When the switch unit 212 receives the near-full signal, it means the buffer 51 is near full currently, and the congestion may occur if the switch unit 212 forwards one more low priority packet to the buffer 51. Thus, the switch unit 212 adjusts its packet arbitration policy as that only the high priority packet is allowed to be forwarded, i.e. the high priority packet can directly pass the direct path 54 to the target device 23, and the low priority packet is not allowed to be forwarded.

(2) When the switch unit 212 receives the warning signal, it means the buffer 51 has only limited empty space currently, and only an important low priority packet is allowed to enter the buffer 51. For example, as described above, if the current to-be-forwarded packet on the packet-forwarding path 213 (or 216) is a low priority packet and there is a subsequent high priority packet to pass the packet-forwarding path 213 (or 216) soon, then the switch unit 212 will forward the current to-be-forwarded low priority packet as if it is a high priority packet, so as to prevent the subsequent high priority packet from being blocked. That is, the switch unit 212 arbitrates the forwarding sequence of the current to-be-forwarded low priority packet by regarding it as the high priority packet. Please note that this upgrade of priority level is temporal and limited to the adjustment of forwarding sequence in this situation, and the upgraded low priority packet is still a low priority packet in nature. This temporally upgraded low priority packet, used to prevent the subsequent high priority packet from being blocked, is then an important low priority packet allowed to enter the buffer 51. Other unimportant low priority packets are not allowed to enter the buffer 51. Thus, when receiving the warning signal, the switch unit 212 adjusts its packet arbitration policy as that only the high priority packet and the low priority packet which is regarded as the high priority packet are allowed to be forwarded.

(3) When the switch unit 212 does not receive the near-full signal and the warning signal, it means the buffer 51 still has enough empty space for storing low priority packets. Thus, the switch unit 212 adjusts its packet arbitration policy as that the high priority packet and the low priority packet which is regarded as the high priority packet are forwarded firstly and the other low priority packet is forwarded secondly.

In one embodiment, the buffering mechanism and the direct path as shown in FIG. 5 are added between any two connected switch units. For example, in the architecture of FIG. 2, a buffering unit and a direct path (not shown) are added on each of the packet-forwarding paths 213 and 216, wherein the buffering unit is used for storing low priority packets, while the direct path is used for passing high priority packets directly. Further, the buffering unit can issue a warning signal to the switch units 211 and 215 when the amount of low priority packets stored in the buffering unit exceeds a warning value. In this situation, the amount of low priority packets stored in the buffering unit is also the low priority weight of the path weight of the packet-forwarding path 213 (or 216). In order to prevent the buffering unit from being overloaded, in the previous point of (2), the adjustment of the packet arbitration policy performed by the switch unit 212 also includes “when the low priority weight of the path weight of the packet-forwarding path 213 (or 216) exceeds the warning value, the current to-be-forwarded low priority packet on the packet-forwarding path 213 (or 216) (i.e. the packet stored in the buffering unit) is temporally upgraded as the high priority packet, so as to forward it earlier. In this manner, more buffering space can be emptied to avoid congestion.

In sum, when performing packet forwarding, the switch unit 212 can dynamically adjust its packet arbitration policy according to both the status of the destination end (i.e. the status of the buffer 51) and the status of the source end (i.e. the path weights of the packet-forwarding paths 213 and 216), such that the high priority packet can reach its destination within the allowable delay range. In this manner, the communication congestion can be avoided, and thus the communication network with QoS requirements can be realized.

The architecture of FIG. 2 can be extended to include more than three switch units, wherein one packet-forwarding path and one token-forwarding path connect between any two connected switch units; each switch unit can be coupled to one or more source devices or target devices. When performing packet forwarding, each switch unit can dynamically adjust its packet arbitration policy according to the path weight of its source packet-forwarding path (i.e. the packet-forwarding path where the packet comes from) and the status of the buffer (located between the switch unit and next switch unit), thereby avoiding the communication congestion.

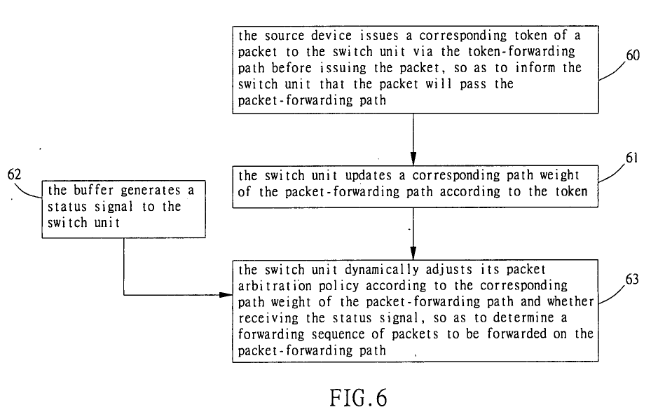

FIG. 6 is a flow chart of a packet arbitration method used in the network system as shown in FIG. 2 and FIG. 5 according to a preferred embodiment of the present invention. The packet arbitration method comprises the steps as follows:

Step 60: the source device 22 (or 24) issues a corresponding token of a packet to the switch unit 212 via the token-forwarding path 214 (or 217) before issuing the packet, so as to inform the switch unit 212 that the packet will pass the packet-forwarding path 213 (or 216) soon.

Step 61: the switch unit 212 updates a corresponding path weight of the packet-forwarding path 213 (or 216) according to the token.

Step 62: the buffer 51 generates a status signal to the switch unit 212.

Step 63: the switch unit 212 dynamically adjusts its packet arbitration policy according to the corresponding path weights of the packet-forwarding paths 213 and 216 and whether receiving the status signal, so as to determine a forwarding sequence of packets to be forwarded on the packet-forwarding paths 213 and 216.

Since the steps 60˜63 have been explained in detail as above, the explanation for these steps is omitted here.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A network system comprising:
a switch network comprising a first switch unit and a second switch unit, wherein a first path and a second path connect between the first and second switch units;
a target device coupled to the second switch unit; and
a source device, coupled to the first switch unit, for issuing a corresponding token of a first packet to the second switch unit via the second path before issuing the first packet to the target device via the first path, so as to inform the second switch unit that the first packet will pass the first path soon;
wherein the second switch unit dynamically adjusts a packet arbitration policy according to the token, so as to determine a forwarding sequence of a second packet to be forwarded on the first path.

2. The network system of claim 1, wherein if the first packet is a high priority packet and the second packet is a low priority packet, the packet arbitration policy determines the forwarding sequence of the second packet by regarding the second packet as the high priority packet.

3. The network system of claim 1, wherein the token comprises a first weight identifier corresponding to the first packet; the first path has a corresponding path weight for indicating a respective amount of to-be-forwarded packets corresponding to each different weight identifier on the first path; the second switch unit updates the path weight according to the token.

4. The network system of claim 3, wherein the second switch unit updates the path weight when forwarding the first packet.

5. The network system of claim 3, wherein the second switch unit adjusts the packet arbitration policy according to the path weight of the first path.

6. The network system of claim 3, wherein the first switch unit comprises a first sub switch unit and the second switch unit comprises a second sub switch unit, wherein the second path is coupled between the first sub switch unit and the second sub switch unit, and the second sub switch unit updates the path weight according to the token.

7. The network system of claim 3, wherein the first packet comprises a header which comprises a request type information, a source identifier and a destination address.

8. The network system of claim 7, wherein the token is generated according to the header of the first packet.

9. The network system of claim 8, wherein the first weight identifier corresponding to the first packet comprises a subset of the request type information.

10. The network system of claim 8, wherein the first weight identifier comprises a subset of the source identifier.

11. The network system of claim 8, wherein the token further comprises a target identifier which is decoded from the destination address.

12. The network system of claim 9, wherein the subset of the request type information comprises a priority level information for indicating a priority level of the first packet.

13. The network system of claim 12, wherein the priority level is a high priority level or a low priority level.

14. The network system of claim 13, wherein the path weight comprises a high priority weight for indicating an amount of high priority packets to be forwarded on the first path.

15. The network system of claim 14, wherein the path weight further comprises a low priority weight for indicating an amount of low priority packets to be forwarded on the first path.

16. The network system of claim 15, further comprising:
a buffer coupled between the second switch unit and the target device, wherein when the second packet is a low priority packet, the second switch unit forwards the second packet to the buffer; when the second packet is a high priority packet, the second switch unit forwards the second packet to the target device directly.

17. The network system of claim 16, wherein the buffer generates a status signal to the second switch unit, wherein the status signal is a near-full signal or a warning signal; the second switch unit dynamically adjusts the packet arbitration policy according to whether receiving the status signal.

18. The network system of claim 17, wherein when the second switch unit receives the near-full signal, the packet arbitration policy is adjusted as that only the high priority packet is allowed to be forwarded.

19. The network system of claim 17, wherein when the second switch unit does not receive the near-full signal, the packet arbitration policy determines the forwarding sequence of the second packet by regarding the second packet as the high priority packet if the high priority weight of the path weight is not zero and the second packet is the low priority packet.

20. The network system of claim 17, wherein when the second switch unit receives the warning signal, the packet arbitration policy is adjusted as that only the high priority packet and the low priority packet which is regarded as the high priority packet are allowed to be forwarded.

21. The network system of claim 17, wherein when the second switch unit does not receive the status signal, the packet arbitration policy is adjusted as that the high priority packet and the low priority packet which is regarded as the high priority packet are forwarded firstly and the other low priority packet is forwarded secondly.

22. The network system of claim 17, further comprising:
a second buffer for temporally storing the low priority packet to be forwarded on the first path;
wherein the packet arbitration policy determines the forwarding sequence of the second packet by regarding the second packet as the high priority packet if the low priority weight of the path weight is larger than a warning value and the second packet is the low priority packet stored in the second buffer.

23. The network system of claim 1, wherein the network system is a Network-on-Chip (NoC) system.

24. A network system comprising:
a switch network comprising a switch unit and a buffer, wherein the buffer generates a status signal to the switch unit, and the status signal is a near-full signal or a warning signal; and
a target device coupled to the buffer and the switch unit;
wherein when a to-be-forwarded packet of the switch unit is a high priority packet, the switch unit forwards the high priority packet to the target device directly; when the to-be-forwarded packet is a low priority packet, the switch unit forwards the low priority packet to the buffer;
wherein the switch unit adjusts a packet arbitration policy according to whether receiving the status signal, so as to determine a forwarding sequence of the to-be-forwarded packet of the switch unit.

25. The network system of claim 24, wherein when the switch unit receives the warning signal, the packet arbitration policy is adjusted as that only the high priority packet and the low priority packet which is regarded as the high priority packet are allowed to be forwarded.

26. The network system of claim 24, wherein when the switch unit receives the near-full signal, the packet arbitration policy is adjusted as that only the high priority packet is allowed to be forwarded.

27. The network system of claim 24, wherein when the second switch unit does not receive the status signal, the packet arbitration policy is adjusted as that the high priority packet and the low priority packet which is regarded as the high priority packet are forwarded firstly and the other low priority packet is forwarded secondly.
